(19) United States
(12) Patent Application Publication
(10) Pub. No.: US 2003/0043357 A1
(43) Pub. Date: Mar. 6, 2003

(54) Vacuum chamber having instrument- mounting bulkhead exhibiting reduced deformation in response to pressure differential, and energy-beam systems comprising same

(75) Inventor: Toshimasa Shimoda, Ageo-Shi (JP)

Correspondence Address: KLARQUIST SPARKMAN, LLP, One World Trade Center, Suite 1600, 121 S.W. Salmon Street, Portland, OR, 97204, US

(73) Assignee: Nikon Corporatoin

(21) Appl. No.: 10/209,738

(22) Filed: Jul. 31, 2002

(30) Foreign Application Priority Data
Aug. 24, 2001 (JP) 2001-253918

(51) Int. Cl. G03B 27/42

(52) U.S. Cl. 355/53

(57) ABSTRACT

Reduced-pressure (“vacuum”) chambers, and microlithographic exposure systems including one or more of such chambers, are disclosed. The vacuum chamber exhibits reduced deformation of a bulkhead of the chamber during evacuation of the chamber or occurrence of a change in pressure differential across the bulkhead. A “pan” (serving as a secondary wall) is situated at a gap distance from the bulkhead. A secondary reduced-pressure chamber is formed in the gap between the pan and the bulkhead. The secondary reduced-pressure chamber is isolated from atmospheric pressure outside the chamber and from the subatmospheric pressure inside the chamber. The differential between atmospheric pressure and the pressure inside the secondary reduced-pressure chamber is exerted on the pan, but the pressure differential has substantially no effect on the bulkhead, thereby reducing deformation of the bulkhead. Reducing deformation of the bulkhead prevents degradations of accuracy, otherwise caused by pressure-change-induced deformation of the bulkhead, of any instruments mounted to the bulkhead.

### FIELD

This disclosure pertains to systems configured to place and process a workpiece inside a chamber evacuated to a subatmospheric pressure. Such systems are used, for example, in any of various irradiation and transfer-exposure apparatus that irradiate a workpiece with an energy beam inside such a chamber. The disclosure also pertains to transfer-exposure apparatus, comprising such a chamber, that include one or more measuring instruments (e.g., alignment-measuring instruments) mounted to a bulkhead or wall of such a chamber. The exposure apparatus are configured to prevent reductions in the operational accuracy and precision of the instrument(s) by controlling deformation of the bulkhead caused by evacuation of the chamber or changes in the pressure differential across the chamber bulkhead (the latter being caused by, e.g., a change in atmospheric pressure).

### BACKGROUND

Many types of apparatus are known that utilize a charged particle beam (e.g., electron beam) or other energy beam for imaging, displaying, workpiece processing, or other practical application. An exemplary apparatus of this general type is a transfer-exposure apparatus, also termed a “microlithography” apparatus, used for transferring a pattern to a suitable substrate. Whereas most conventional microlithography systems utilize a beam of vacuum ultraviolet light for making the exposure, an emerging class of microlithography systems utilize a charged particle beam (e.g., electron beam or ion beam) or an X-ray beam for making the exposure.

The summary below is set forth in the context of an electron-beam (EB) microlithography system, by way of example, which is used mainly for transferring intricate circuit patterns for integrated circuits and the like onto semiconductor wafers. In a typical EB microlithography system an electron beam is directed onto a layer of “resist” coated on a surface of a semiconductor wafer. Since an electron beam is blocked, and thus attenuated, by collisions with gas molecules, the inside of the microlithography system (especially in the beam trajectory) is maintained at high vacuum.

To create the high-vacuum environment, a vacuum chamber is used that typically comprises two portions, a wafer-vacuum chamber and a reticle-vacuum chamber. Whenever this vacuum chamber is evacuated to a high vacuum, the walls (bulkheads) of the chamber exhibit some deformation due to the resulting pressure differential of the inside of the chamber (high vacuum) versus the outside of the chamber (normally at ambient atmospheric pressure). Changes in atmospheric pressure also can cause an accompanying change in deformation of the chamber walls and bulkheads. Whenever bulkheads of such chambers deform, the attitudes and positions of measuring instruments attached to the affected bulkhead change accordingly. For example, in an EB microlithography system, certain auto-focus (AF) and alignment (AL) instruments and/or optical microscopes or the like typically are installed in the vacuum chamber on a bulkhead of the chamber. A change in attitude or position of an AF or AL instrument mounted on a bulkhead experiencing deformation can produce a corresponding decrease in the accuracy of pattern transfer performed using the microlithography system.

According to conventional thinking, the way to prevent deformation of the bulkheads of vacuum chambers (and the consequential adverse effect on accuracy of AF and AL instruments mounted on the bulkheads) is to increase the rigidity of the chamber by providing the bulkheads with stout ribs and/or constructing the bulkheads of materials having a relatively high Young's modulus. However, with such approaches, increasingly stringent demands for measurement accuracy and precision of AF and AL systems must be met by corresponding substantial increases in the size and mass of the overall vacuum-chamber structure, which unavoidably increases the overall size of the apparatus. Therefore, other countermeasures are needed to avoid this trend.

### SUMMARY

In view of the problems experienced with conventional apparatus and methods as summarized above, the invention provides, inter alia, systems comprising vacuum chambers that are more resistant to decreases in the accuracy and precision of instruments mounted on a bulkhead of the vacuum chambers. These ends are met by reducing the effects of deformation of chamber bulkheads during evacuation of the chamber or during changes in the ambient pressure outside the chamber.

According to a first aspect of the invention, chambers are provided for performing a process on a workpiece at a pressure that is lower inside the chamber than outside the chamber. An embodiment of such a chamber comprises walls and at least one bulkhead that collectively define the chamber. A secondary wall is situated outside the chamber relative to the bulkhead. The secondary wall defines a gap between the secondary wall and the bulkhead. The gap defines a secondary reduced-pressure chamber that is pressurizable at a pressure intermediate the respective pressures inside and outside the chamber. The secondary wall also is deformable relative to the bulkhead in response to a differential of pressure inside the secondary reduced-pressure chamber relative to outside the chamber. The secondary reduced-pressure chamber desirably is isolated from pressure outside the chamber and from pressure inside the chamber.

The chamber can be configured to be evacuated to a high vacuum relative to atmospheric pressure outside the chamber. In this configuration, the secondary reduced-pressure chamber desirably is connected to a vacuum pump configured to evacuate the secondary reduced-pressure chamber to a less-high vacuum level than inside the chamber.

The chamber can further comprise a measurement instrument and a seal means. In this configuration the measurement instrument is mounted to the bulkhead and extends through the secondary wall. The seal means is situated and configured to establish a seal between the secondary wall and the measurement instrument such that the secondary wall can move relative to the measurement instrument, without breaking the seal, in response to the differential of pressure. The measurement instrument can be configured to measure a characteristic of an object inside the chamber. The seal means can comprise a closure member extending radially from a surface of the secondary wall to the measurement instrument, and an elastomeric sealing member extending from the closure member to the measurement instrument.

By way of example, the chamber can be a wafer chamber of a microlithography system, wherein the object is a semiconductor wafer being processed lithographically in the chamber. In this configuration the measurement instrument can be used for measuring at least one of focus and alignment of the object inside the chamber. Alternatively, the chamber can be a reticle chamber of a microlithography system.

Further by way of example, the pressure inside the chamber can be a high vacuum, in which instance the pressure inside the secondary reduced-pressure chamber is an intermediate vacuum, and the pressure outside the chamber is ambient atmospheric pressure.

According to another aspect of the invention, apparatus are provided for housing an object in a subatmospheric-pressure. An embodiment of such an apparatus comprises a chamber collectively defined by vessel walls and at least one bulkhead. The chamber is sized to contain the object and to contain an atmosphere evacuated to the subatmospheric pressure. The apparatus includes an instrument-mounting member mounted to the bulkhead outside the chamber, and an instrument mounted to the instrument-mounting member and configured to measure a characteristic of the object in the chamber. The apparatus also includes a deformation-reducing device for reducing deformation of the bulkhead in response to a differential of pressure of the subatmospheric pressure inside the chamber relative to the pressure outside the chamber. The deformation-reducing device desirably comprises a secondary wall situated outside the chamber relative to the bulkhead and defining a gap between the bulkhead and the secondary wall, wherein the gap defines a secondary reduced-pressure chamber that is evacuated to a subatmospheric pressure intermediate the subatmospheric pressure in the chamber and the pressure outside the chamber. The secondary wall desirably deforms relative to the bulkhead in response to a differential of pressure inside the secondary reduced-pressure chamber relative to the pressure outside the secondary reduced-pressure chamber and outside the chamber. The apparatus can further comprise a seal means and/or vacuum pump as summarized above.

The apparatus can further comprise a stage situated inside the chamber and configured to hold the object inside the chamber. If the object is a reticle or substrate, then the stage can be, for example, a reticle stage or wafer stage, respectively, of a microlithographic exposure system. In this instance, the instrument can be a reticle autofocus system, a reticle alignment system, a wafer autofocus system, or a wafer alignment system.

According to another aspect of the invention, systems are provided for irradiating an object with an energy beam. An embodiment of such a system comprises a chamber collectively defined by vessel walls and at least one bulkhead, the chamber being sized to contain the object for irradiation with the energy beam and to contain an atmosphere evacuated, at least during the irradiation, to a subatmospheric pressure. The system also includes an optical system situated so as to irradiate the object in the chamber with the energy beam. The system also includes an instrument-mounting member mounted to the bulkhead outside the chamber, and an instrument mounted to the instrument-mounting member and configured to measure a characteristic of the object in the chamber. The system also includes a deformation-reducing device for reducing deformation of the bulkhead in response to a differential of pressure inside the chamber relative to pressure outside the chamber. The deformation-reducing device can comprise a secondary wall situated outside the chamber relative to the bulkhead and defining a gap between the bulkhead and the secondary wall, wherein the gap defines a secondary reduced-pressure chamber that is evacuated to a subatmospheric pressure intermediate the subatmospheric pressure in the chamber and the pressure outside the chamber.

As summarized above, the secondary wall desirably is configured to deform relative to the bulkhead in response to a differential of pressure inside the secondary reduced-pressure chamber relative to the pressure outside the secondary reduced-pressure chamber and outside the chamber. The system further can include a seal means and/or vacuum pump as summarized above.

If the object is a lithographic wafer substrate, then the optical system can be a projection-optical system situated and configured to illuminate the substrate inside the chamber with an energy beam so as to expose the substrate lithographically with a pattern image. In this configuration the energy beam can be, for example, a beam of vacuum UV light, extreme UV light, or X-ray light, or a charged particle beam.

According to yet another aspect of the invention, lithographic exposure systems are provided for exposing a substrate with a pattern. An embodiment of such a system comprises a first chamber collectively defined by chamber walls and at least one bulkhead. The first chamber is configured: (a) to contain the substrate for exposure, (b) to irradiate the substrate with an energy beam capable of imprinting the pattern on the substrate, and (c) to contain a respective atmosphere evacuated, at least during the exposure, to a respective subatmospheric pressure. The system also includes a source of the energy beam situated to direct the energy beam into the first chamber to expose the substrate. The source can comprise a projection-optical system coupled to the bulkhead of the first chamber. An instrument-mounting member is mounted to the bulkhead outside the first chamber, and an instrument is mounted to the instrument-mounting member and configured to measure a characteristic of the substrate in the first chamber. The system includes a respective deformation-reducing device for reducing deformation of the bulkhead in response to a differential of pressure inside the first chamber relative to the pressure outside the first chamber.

The system can further comprise a second chamber collectively defined by chamber walls and at least one bulkhead. Similar to the first chamber, the second chamber is configured: (a) to contain a reticle defining a pattern to be exposed onto the substrate, (b) to irradiate the reticle with an illumination beam, and (c) to contain a respective atmosphere evacuated, at least during exposure, to a respective subatmospheric pressure. An illumination-optical system is situated and configured to direct the illumination beam into the second chamber to illuminate the reticle. An instrument-mounting member is mounted to the respective bulkhead outside the second chamber, and an instrument is mounted to the instrument-mounting member and configured to measure a characteristic of the reticle in the second chamber. The system includes a respective deformation-reducing device for reducing deformation of the bulkhead of the second chamber in response to a differential of pressure inside the second chamber relative to pressure outside the second chamber.

The instrument mounted to the instrument-mounting member of the second chamber can be, for example, a reticle autofocus system or a reticle alignment system.

The deformation-reducing device can comprise a secondary wall situated outside the first chamber relative to the bulkhead. The secondary wall defines a gap between the bulkhead and the secondary wall. The gap defines a secondary reduced-pressure chamber that is evacuated to a subatmospheric pressure intermediate the subatmospheric pressure in the first chamber and the pressure outside the first chamber. The secondary wall desirably is configured to deform relative to the bulkhead in response to a differential of pressure inside the secondary reduced-pressure chamber relative to pressure outside the secondary reduced-pressure chamber and outside the first chamber. The system can include a seal means and/or vacuum pump as summarized above. The vacuum pump can be configured to change the subatmospheric pressure in the secondary reduced-pressure chamber in response to a change in pressure outside the first chamber.

According to yet another aspect of the invention, methods are provided (in the context of methods for processing a workpiece under a subatmospheric-pressure condition established within a chamber collectively defined by vessel walls and at least one bulkhead) for reducing deformations of the bulkhead resulting from changes in a differential of pressure inside of the chamber relative to pressure outside of the chamber. An embodiment of such a method comprises placing a secondary wall outside the chamber relative to the bulkhead so as to define a gap between the secondary wall and the bulkhead, the gap defining a secondary reduced-pressure chamber. The secondary reduced-pressure chamber is evacuated to a subatmospheric pressure intermediate the subatmospheric pressure in the chamber and the pressure outside the chamber, wherein the secondary wall deforms relative to the bulkhead in response to a differential of pressure inside the secondary reduced-pressure chamber relative to the pressure outside the secondary reduced-pressure chamber and outside the chamber.

According to yet another aspect of the invention, microlithography systems are provided that illuminate a selected region on a pattern-defining reticle with an energy beam, and project and focus the energy beam, that has passed through the reticle, onto a selected region on a sensitive substrate so as to transfer the pattern from the reticle to the sensitive substrate. An embodiment of such a system comprises a reticle-vacuum chamber that accommodates a reticle stage on which the reticle is mounted. The reticle-vacuum chamber is defined by walls and at least one bulkhead. The system also includes a wafer-vacuum chamber that accommodates a wafer stage, on which the sensitive substrate is mounted, wherein the wafer-vacuum chamber is defined by walls and at least one bulkhead. A respective instrument is mounted on the bulkhead of the reticle-vacuum chamber for measuring a characteristic of the reticle. A respective instrument is mounted on the bulkhead of the wafer-vacuum chamber for measuring a characteristic of the substrate. The system also includes a deformation-reducing device for reducing deformation of the respective bulkhead of at least one of the chambers in response to a pressure differential being established in the respective chamber relative to outside the respective chamber.

The deformation-reducing device desirably comprises a respective secondary wall situated outside the respective chamber relative to the respective bulkhead and defining a gap between the respective bulkhead and respective secondary wall. The gap defines a respective secondary reduced-pressure chamber that is evacuated to a respective subatmospheric pressure intermediate the subatmospheric pressure in the respective chamber and the pressure outside the respective chamber. The secondary wall desirably deforms relative to the respective bulkhead in response to a differential of pressure inside the respective secondary reduced-pressure chamber relative to pressure outside the respective secondary reduced-pressure chamber and outside the respective chamber. The system can include a seal means and/or vacuum pump as summarized above.

In a more specific embodiment of the system, a first deformation-reducing device is provided for reducing deformation of the bulkhead of the reticle-vacuum chamber, and a second deformation-reducing device is provided for reducing deformation of the wafer-vacuum chamber, in response to respective pressure differentials being established in the respective chambers relative to outside the respective chambers. In this system, each deformation-reducing device desirably comprises a respective secondary wall situated outside the respective chamber relative to the respective bulkhead and defining a gap between the respective bulkhead and respective secondary wall. Each gap defines a respective secondary reduced-pressure chamber that is evacuated to a respective subatmospheric pressure intermediate the subatmospheric pressure in the respective chamber and the pressure outside the respective chamber. As noted above, each secondary wall desirably is configured to deform relative to the respective bulkhead in response to a differential of pressure inside the respective secondary reduced-pressure chamber relative to pressure outside the respective secondary reduced-pressure chamber and outside the respective chamber. Seal means and vacuum pumps, as summarized above, can be included.

The respective instruments mounted on the bulkhead of the reticle-vacuum chamber can be, for example, a reticle autofocus system and/or a reticle alignment system. Similarly, the respective instruments mounted on the bulkhead of the wafer-vacuum chamber can be, for example, a wafer autofocus system and/or a wafer alignment system.

The bulkhead of the reticle-vacuum chamber and the bulkhead of the wafer-vacuum chamber can be mounted to opposite ends of a projection-optical system extending between the chambers. In such a system the bulkhead of the reticle-vacuum chamber can be configured as a reticle optical plate, and the bulkhead of the wafer-vacuum chamber can be configured as a wafer optical plate.

The reticle-vacuum chamber can comprise a second bulkhead situated opposite the respective bulkhead relative to the respective walls. In such a configuration the second bulkhead can be connected to an illumination-optical system.

The reticle-vacuum chamber can be coupled to a reticle-loader chamber and a reticle load-lock chamber, and the wafer-vacuum chamber can be coupled to a wafer-loader chamber and a wafer load-lock chamber.

Since various systems summarized above include a mechanism that controls deformation of the bulkhead occurring during evacuation of the respective chamber and/or in response to a change in atmospheric pressure, misalignments and/or positional shifts of instruments mounted on the bulkhead are reduced. This allows higher-accuracy work to be performed on an object or workpiece located in the chamber, such as workpiece processing, workpiece irradiation, or pattern transfer to the workpiece.

Exemplary energy-beam irradiation systems include, but are not limited to, lithographic-exposure systems, coordinate-measurement systems, scanning electron microscopes, etc. Exemplary instruments include, but are not limited to, autofocus (AF) devices (see, e.g., Japan Kôkai Patent Document Nos. Hei 6-283403 and Hei 8-64506, referred to herein as “AF” devices), alignment devices (see, e.g., Japan Kôkai Patent Document No. Hei 5-21314, referred to herein as “AL” devices), and interferometers.

With respect to any of the secondary reduced-pressure chambers referred to above, by making the pressure inside the chamber and the pressure inside the secondary reduced-pressure chamber nearly equal to each other, deformation of the bulkhead is reduced. This is because, under such conditions, the differential of internal versus external pressure across the bulkhead has virtually no effect on the bulkhead, especially near instrument mounts attached to the bulkhead. If there is a change in the pressure differential, then the respective secondary wall is deformed rather than the bulkhead. Also, by moving the secondary wall instead of the bulkhead, any instruments mounted on the bulkhead experience correspondingly less movement in response to the change in pressure differential. The seal means established between the secondary wall and the instruments or their mountings provides a sliding or otherwise deformable gasket between the instruments (or instrument mounts) and the secondary wall. The seal means can be, for example, O-rings or diaphragms extending between the secondary wall and the instrument mounts or instruments.

Controlling deformation of the bulkhead generally results in substantially reduced tilting, misalignment, distortion, or other undesired movement of the instrument mounts or instruments themselves. For example, a “distortion” to an instrument can arise in a situation in which there is no actual tilting of the instrument but only a slight shift of the position of the instrument mounts (or instruments). If this distortion is very slight, the measurement accuracy of the instruments is not affected significantly in many instances. But, a more pronounced distortion (as experienced in conventional apparatus) substantially can reduce the performance accuracy of the instruments.

The pressure inside any of the chambers referred to above can be regulated according to changes in the pressure external to the chambers. Thus, the positioning of the instrument mounts can be optimized by intentional control of the pressure of the respective secondary reduced-pressure chambers.

The foregoing and additional features and advantages of the invention will be more readily apparent from the following detailed description, which proceeds with reference to the accompanying drawings.

### BRIEF DESCRIPTION OF THE DRAWINGS

FIG. 1 is a schematic elevational diagram showing the overall configuration of a representative embodiment of a microlithographic exposure system according to the invention.

FIG. 2 is a plan view of the wafer optical plate of the microlithographic exposure system of FIG. 1, showing certain components associated with the wafer optical plate.

FIG. 3 is an elevational section, along the line X-X, of the wafer optical plate of FIG. 2, showing the location of the wafer auto-focus (AF) device.

FIG. 4 is an enlarged elevational section showing details of the wafer AF device shown in FIG. 3.

FIG. 5 is an elevational section viewed in the direction of the arrow Y in FIG. 4.

FIG. 6(A) is a schematic elevational depiction of deformation of the wafer optical plate that occurs whenever no pan is provided in association with the wafer optical plate.

FIG. 6(B) schematically shows the absence of deformation of the wafer optical plate achieved by including a pan in association with the wafer optical plate.

FIG. 7 is a schematic elevational diagram showing certain optical relationships in a charged-particle-beam (notably electron-beam) microlithography system.

### DETAILED DESCRIPTION

The invention is described below in the context of several representative embodiments that are not intended to be limiting in any way. Also, the description is made largely in the context of an electron-beam microlithography system as a representative charged-particle-beam (CPB) microlithography system and a representative system employing a vacuum chamber. It will be understood that the details described below can be applied with equal facility to any of various other types of microlithography systems and other systems employing a vacuum chamber, such as ion-beam, X-ray, or extreme ultraviolet (EUV) microlithography systems and to other systems that utilize one or more charged particle beams, EUV beams, or X-ray beams.

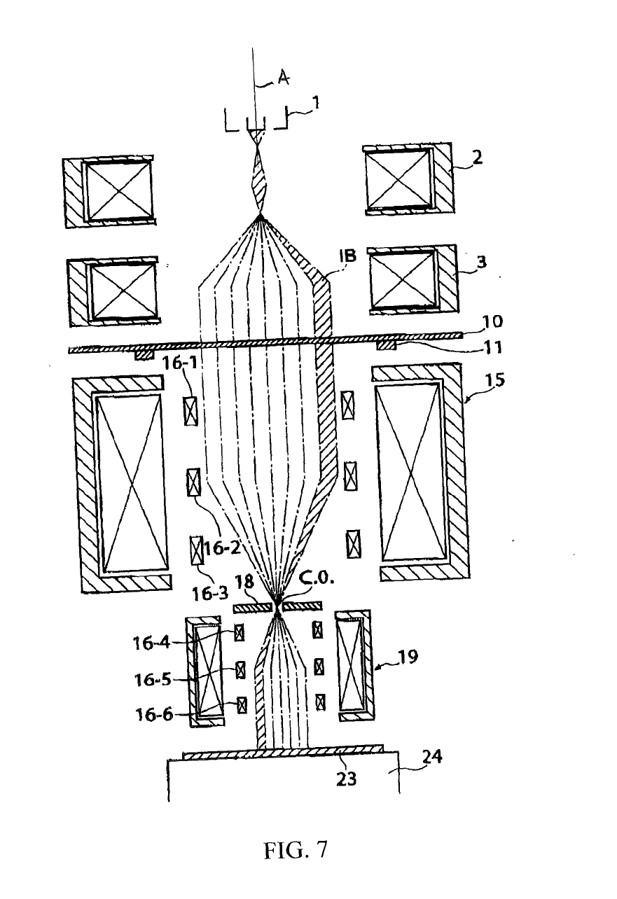

An overview of the overall construction of an electron-beam (EB) microlithography system and of the imaging relationships in such a system is provided in FIG. 7. In the depicted system, an electron gun 1 is situated the extreme upstream end of an EB optical system and emits an electron beam (“illumination beam” IB) in the downstream direction. A condenser lens 2 and an illumination lens 3 are situated downstream of the electron gun 1, and the illumination beam IB passes through the lenses 2, 3 to illuminate a pattern-defining reticle 10. In FIG. 7, the EB optical system upstream of the reticle 10 (termed the “illumination-optical system”) also includes other components such as a shaping aperture, a blanking deflector, a blanking aperture, and an illumination-beam deflector that are not shown but are well understood in the art. The primary components in the illumination-optical system are the lenses 2, 3. The illumination beam IB, shaped and appropriately deflected in the illumination-optical system, sequentially scans the reticle 10 to illuminate “subfields” on the reticle. Each subfield defines a respective portion of the overall pattern defined by the reticle 10. The lateral distance over which the illumination beam IB is scanned is within the optical field of the illumination-optical system.

As noted above, the reticle 10 has a multiple subfields that are arranged on the reticle in a rectilinear array. The reticle is mounted on a movable reticle stage 11. Subfields on the reticle located outside the optical field of the illumination-optical system are brought to within the optical field (for illumination) by movement of the reticle stage 11 within a plane perpendicular to the optical axis A.

Downstream of the reticle 10 is the “projection-optical system” comprising a primary projection lens 15 and a secondary projection lens 19 for projecting and forming an image of the illuminated subfield on the appropriate location on a “sensitive” substrate (resist-coated wafer) 23. The projection-optical system also includes deflectors 16 (denoted 16-1, 16-2, 16-3, 16-4, 16-5, 16-6 in the figure) used for aberration correction and for achieving a desired image registration on the wafer. Portions of the illumination beam passing through an illuminated subfield on the reticle 10 thus become a “patterned beam” that carries an aerial image of the illuminated subfield. The aerial image is formed at a specified position on the wafer 23 by means of the projection lenses 15, 19 and the deflectors 16. As noted, the upstream-facing surface of the wafer 23 is coated with a suitable resist that, upon receiving an appropriate “dose” of the patterned beam, becomes imprinted with the respective image. Thus, the pattern on the reticle 10 is transferred onto the wafer. Transfer normally is at demagnification, by a factor of, e.g., ¼.

A crossover C.O. is formed at a point on the optical axis at which the axial distance between the reticle 10 and wafer 23 is divided by the demagnification (reduction) ratio. A contrast aperture 18 is disposed at the position of the crossover. The contrast aperture 18 blocks electrons of the patterned beam that have experienced substantial forward-scattering during passage through non-patterned portions of the reticle 10. Thus, these scattered electrons do not reach the wafer 23.

The wafer 23 is mounted by an electrostatic chuck on a wafer stage 24 that is movable in the X and Y directions perpendicular to the optical axis A. By synchronously scanning the reticle stage 11 and wafer stage 24 in opposite directions, the various portions of the pattern situated beyond the optical field of the projection-optical system are exposed sequentially.

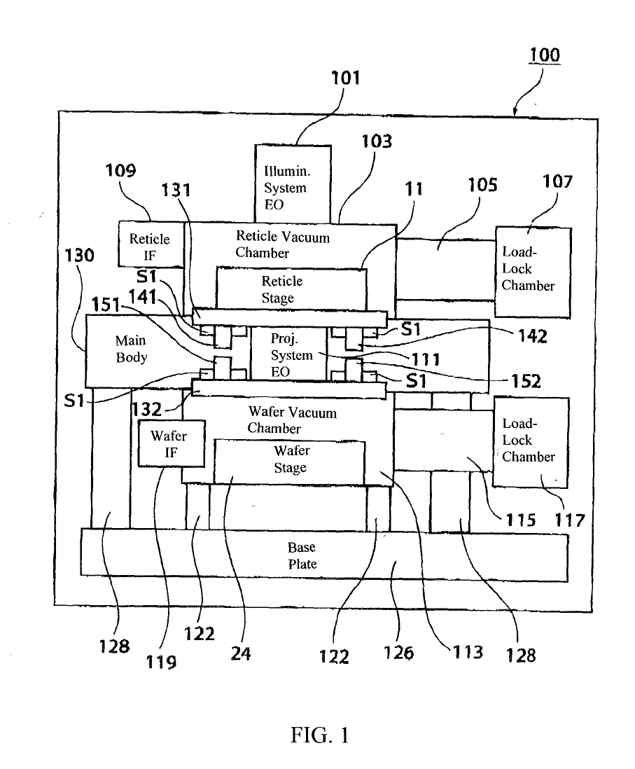

Turning now to FIGS. 1-5, a microlithography (“exposure”) system 100 according to a representative embodiment is shown, wherein the system 100 is representative of any of various systems including a vacuum chamber. In the depicted apparatus, an illumination-optical-system (IOS) column 101 is situated at the upstream end of the apparatus 100 (top of the figure, labeled the “illumination system electron optics” (EO)). The electron gun 1, condenser lens 2, illumination lens 3, and other components of the illumination-optical system discussed above are disposed inside the IOS column 101. A reticle-vacuum chamber 103, situated “below” the IOS column 101, contains the reticle stage 11.

A reticle-loader chamber 105 and reticle load-lock chamber 107, shown at the right in FIG. 1, are connected to the reticle-vacuum chamber 103. A robotic manipulator (not shown), used for reticle handling, is situated inside the reticle-loader chamber 105. The manipulator operates, for example, to replace an existing reticle on the reticle stage 11 with a new reticle waiting inside the reticle-loader chamber 105. Whenever reticles are moved into the reticle-vacuum chamber 103 from outside the exposure system or out of the reticle-vacuum chamber 103 to outside the exposure system, such movements are made by the manipulator via the reticle-loader chamber 105 though the reticle load-lock chamber 107. Respective vacuum pumps (not shown, but well understood in the art) are connected to each of the reticle-vacuum chamber 103 and the reticle load-lock chamber 107. The interior of the IOS column 101, as well as the interior of the projection-optical-system (POS) column 111 discussed below, normally are evacuated to high vacuum.

A reticle interferometer (IF) 109, shown at the left in FIG. 1, is mounted in the reticle-vacuum chamber 103. The reticle interferometer 109 is connected to a controller (not shown). Accurate data regarding the position of the reticle stage 11 are produced by the reticle interferometer 109 and routed to the controller. The controller, in turn, produces reticle-movement commands routed to the reticle stage 11 as required in response to the reticle-position data. Thus, the position of the reticle stage 11 is controlled accurately in real time.

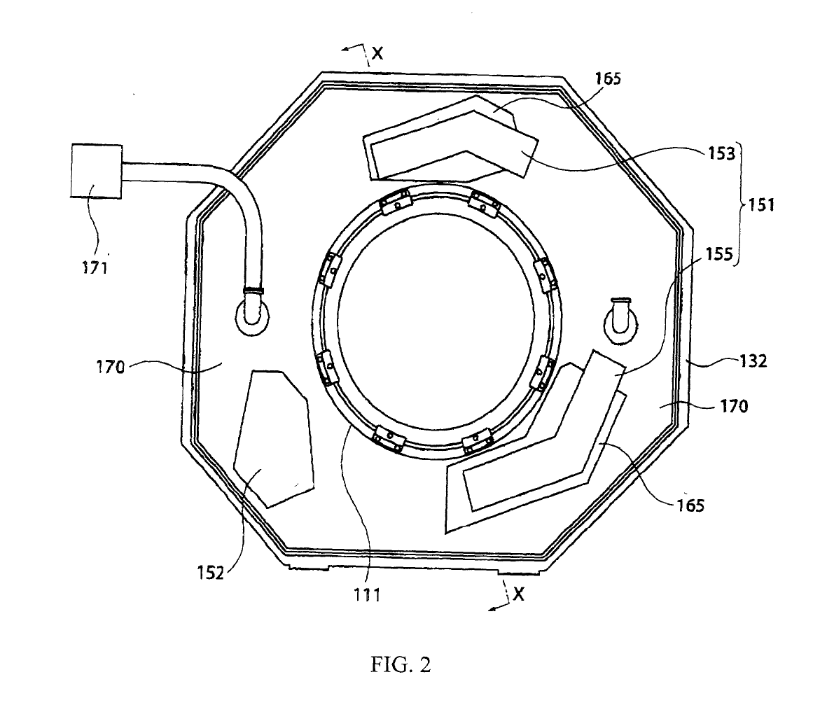

The reticle stage 11 is mounted to an upstream-facing surface of a “reticle optical plate” 131 (serving as a chamber bulkhead and instrument-mounting plate). A “wafer optical plate” 132 (chamber bulkhead) is situated downstream of the reticle optical plate 131. The POS column 111 is disposed between the optical plates 131, 132, wherein each of the optical plates serves as a respective bulkhead of the respective chamber. In the depicted embodiment, each optical plate 131, 132 is configured as a respective octagonal plate fabricated from mild steel plate or the like (see FIG. 2). The primary projection lens 15 and secondary projection lens 19 are disposed inside the POS column 111, which is evacuated to high vacuum.

A reticle-autofocusing (AF) system 141 and reticle-alignment (AL) system 142 (as exemplary “instruments”) are mounted on the downstream-facing (“bottom”) surface of the reticle optical plate 131, and a wafer AF system 151 and wafer AL system 152 (as exemplary “instruments”) are mounted on the upstream-facing (“top”) surface of the wafer optical plate 132, around the perimeter of the POS column 111, as discussed in detail below. A “main body” 130 is situated laterally between the two optical plates 131, 132.

A wafer-vacuum chamber 113 is disposed downstream of the wafer optical plate 132. The wafer stage 24 and related components are situated inside the wafer-vacuum chamber 113. A wafer-loader chamber 115 and wafer load-lock chamber 117, shown on the right in FIG. 1, are connected to the wafer-vacuum chamber 113. Respective vacuum pumps (not shown) are connected to each of the wafer-vacuum chamber 113 and the wafer load-lock chamber 117.

A wafer interferometer (IF) 119, shown at the left in FIG. 1, is situated inside the wafer-vacuum chamber 113. The wafer interferometer 119 is connected to the controller (not shown). Accurate data concerning the position of the wafer stage 24 are produced by the wafer interferometer 119 and routed to the controller. The controller, in turn, produces wafer-movement commands routed to the wafer stage 24 as required in response to the wafer-position data. Thus, the position of the wafer stage 24 is controlled accurately in real time.

The wafer-vacuum chamber 113 is situated on a-stand 122 mounted to a base plate 126. The main body 130, discussed above, is supported on the base plate 126 by a stand 128 providing active attenuation of vibrations between the base plate 126 and the main body 130.

Structures associated with the wafer AF system 151, by way of example, are shown in FIGS. 2-5. The respective structures of the wafer AF system 151 and reticle AF system 141 are similar to each other, and the respective structures of the wafer AL system 152 and reticle AL system 142 are similar to each other.

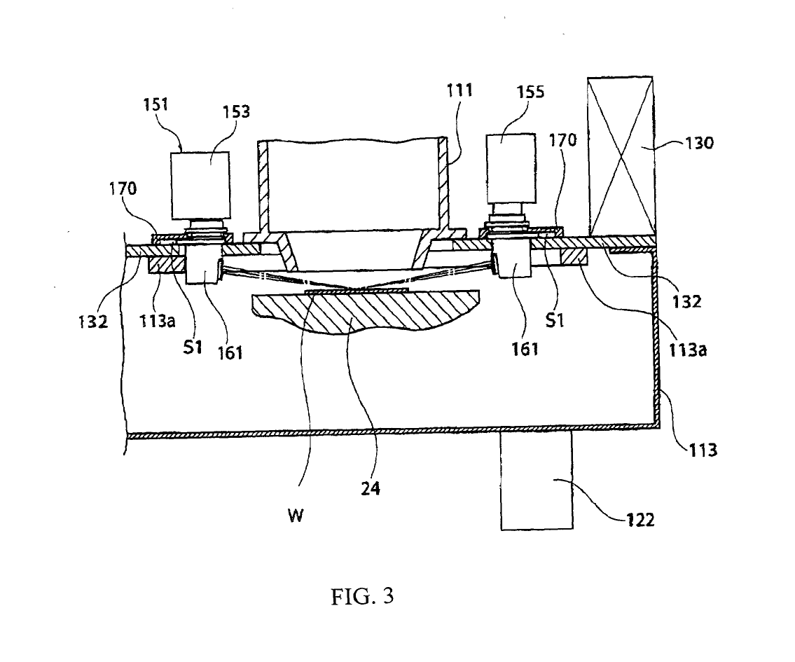

The wafer AF system 151, as shown in FIGS. 2-3, comprises a light-transmission device 153 and a light-reception device 155. The light-transmission device 153 and light-reception device 155 are situated on opposite sides of the POS column 111, with the POS column situated between them. Signal light emitted from the light-transmission device 153 impinges on the “top” (upstream-facing) surface of the wafer W on the wafer stage 24, and signal light reflected from the wafer surface is received by the light-reception device 155. Meanwhile, the wafer AL system 152 (not shown in FIG. 3) is situated at a specified position just outside the perimeter of the POS column 111, away from the light-transmission device 153 and light-reception device 155 of the wafer AL system 152. Measurement data produced by the wafer AF system 151 pertain to the measured position of an existing pattern on the wafer or of a mark plate on the wafer stage 24. These data are used for registering the relative positions of the existing alignment-mark pattern provided on the wafer 23 or on a pattern to be formed next on the wafer.

The wafer AF system 151 can have a conventional configuration such as disclosed in Japan Kôkai Patent Publication No. Hei 6-283403 and Japan Kôkai Patent Publication No. Hei 8-64506, and the wafer AL system 152 can have a conventional configuration such as disclosed in Japan Kôkai Patent Publication No. Hei 5-21314.

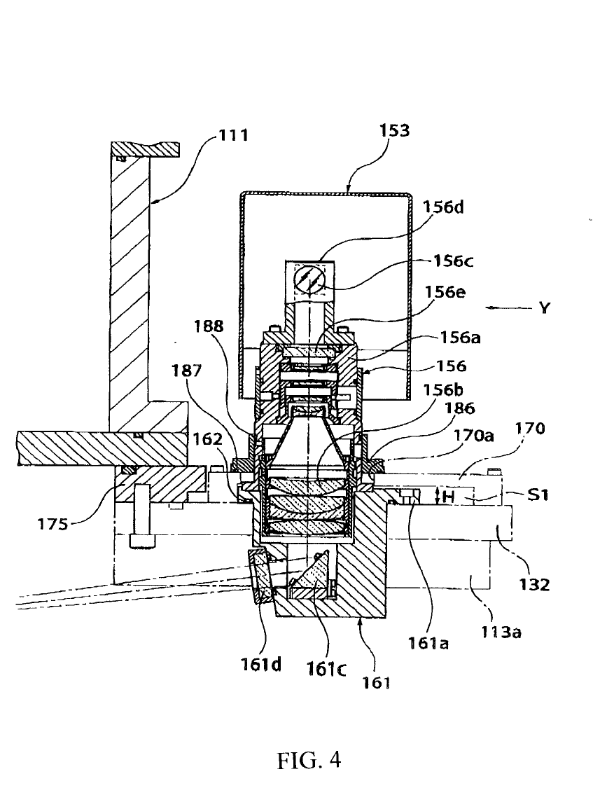

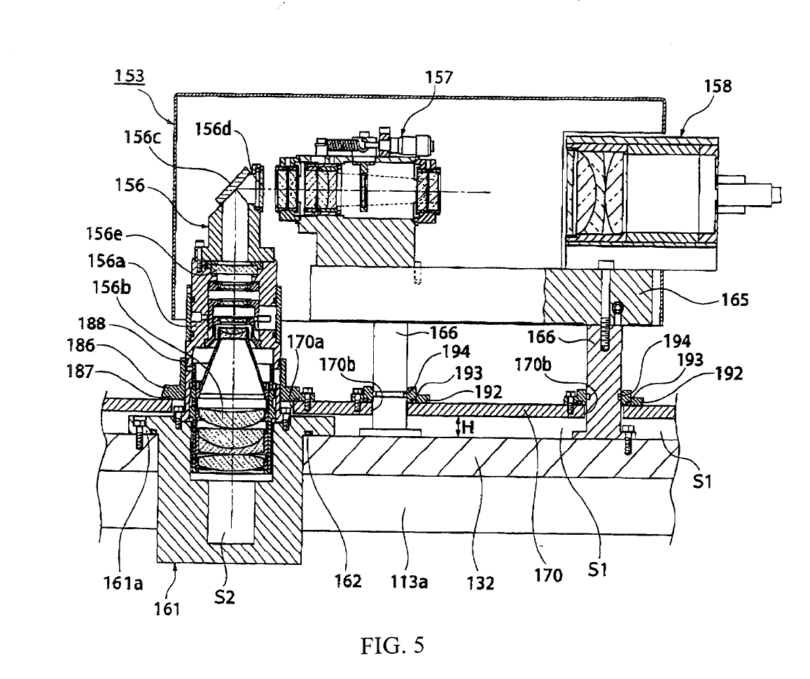

Structures in the vicinity of the light-transmission device 153 of the wafer AF system 151 are shown in FIGS. 4 and 5. Turning first to FIG. 5, the light-transmission device 153 comprises a vertical lens column 156, a horizontal lens column 157, and a light source 158. The vertical lens column 156 includes an objective lens 156b and vacuum-bulkhead window 156e situated at the “bottom” and “top,” respectively, of an AF lens column 156a. A mirror 156c and window 156d are situated at the “upper” end of the AF lens column 156a.

As shown in FIGS. 4 and 5, a box-shaped mirror chamber 161 is attached to the “bottom” of the AF lens column 156a. A flange 161a extends outward around the circumference of an opening at the “top” of the mirror chamber 161. The mirror chamber 161 extends through an opening in the wafer optical plate 132 and an upper lip 113a of the wafer-vacuum chamber 113, such that the “lower” portion of the mirror chamber 161 extends into the interior of the wafer-vacuum chamber 113. The flange 161 a of the mirror chamber 161 is attached to the “top” surface of the wafer optical plate 132, with an O-ring seal 162 therebetween. A mirror 161c and window 161d are situated inside the mirror chamber 161 (FIG. 4).

As shown in FIG. 5, the horizontal lens column 157 and light source 158 are attached to a stand 165. The stand 165 is supported firmly by legs 166 mounted to the “top” surface of the wafer optical plate 132.

As shown in FIG. 2, a “pan” 170 is disposed over nearly the entire “top” surface of the wafer optical plate 132. The pan 170 serves as a secondary wall to the wafer optical plate 132, and defines a gap H (FIGS. 4 and 5) between the pan 170 and the wafer-optical plate 132. A secondary reduced-pressure chamber S1 is formed in the space between the “bottom” surface of the pan 170 and the “top” surface of the wafer optical plate 132. The pan 170 desirably is made from a relatively low-mass metal plate, such as aluminum, to allow the pan to flex, as described further below. As shown in FIGS. 4 and 5, the pan 170 is situated “above” the flange 161 a of the mirror chamber 161. The secondary reduced-pressure chamber S1 is connected to and evacuated by a vacuum pump (not shown in FIGS. 4 and 5, but see item 171 in FIG. 2). The secondary reduced-pressure chamber S1 is connected to a space S2, in which the mirror 161c is located, inside the mirror chamber 161.

The pan 170 defines a hole 170a through which the vertical lens column 156 extends and respective holes 170b through which the legs 166 of the stand 165 extend. An annular closure member 186 extends radially on the “top” surface of the pan 170 to cover space between the hole 170a and the AF lens column 156a. The mounting of the closure member 186 with the pan 170 is sealed with an O-ring 187 (or analogous elastomeric seal, such as a diaphragm), and the space between the inside diameter of the closure member 186 and the outside diameter of the AF lens column 156a is sealed with an O-ring 188 (or analogous elastomeric seal). The O-ring 182 allows a small amount of movement of the pan 170 relative to the AF lens column 156a. Meanwhile, respective annular closure members 192 extend radially on the “top” surface of the pan 170 to cover respective spaces between the holes 170b and the outer surfaces of the legs 166. The mounting of each closure member 192 with the pan 170 is sealed with a respective O-ring 193, and the space between the inside diameter of each closure member 192 and the outside diameter of each leg 166 is sealed with a respective O-ring 194.

The secondary reduced-pressure chamber S1 between the “bottom” surface of the pan 170 and the “top” surface of the wafer optical plate 132 is isolated from the atmospheric-pressure space outside the system and from the vacuum environment inside the wafer-vacuum chamber 113. The vacuum pump 171 (FIG. 2) is connected to the secondary reduced-pressure chamber SI and operates to reduce and regulate the pressure inside the secondary reduced-pressure chamber SI. A distortion sensor (not shown) can be mounted on the inner surface of the mirror chamber 161 for measuring deformation of the mirror chamber 161 and pan 170, allowing the pressure inside the secondary reduced-pressure chamber S I to be regulated appropriately.

Item 175 in FIG. 4 is an annular member situated between the “bottom” surface of the POS lens column 111 and the “top” surface of the wafer optical plate 132. The annular member 175 desirably is made from a non-magnetic material, such as stainless steel, and serves to interrupt an electromagnetic circuit that otherwise would form between the POS column 111 and the wafer optical plate 132, both of which are made of magnetic materials.

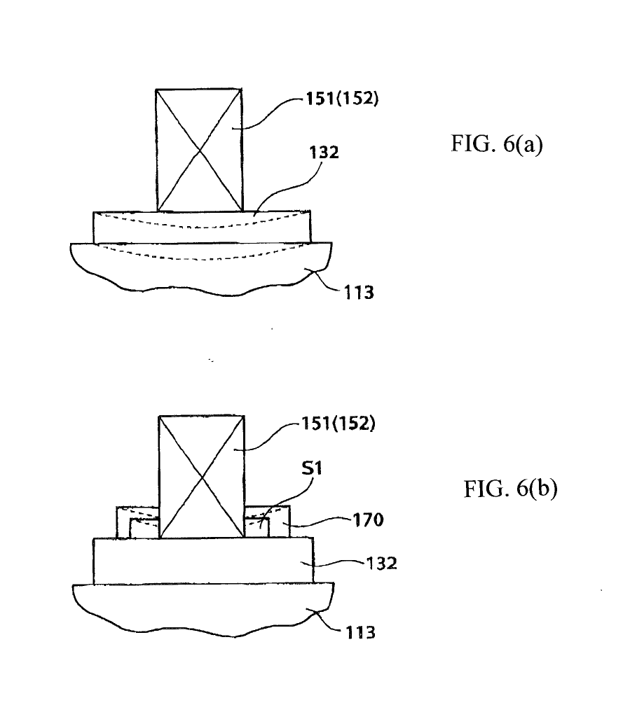

Turning now to FIG. 6(A), a wafer AF system 151 (or wafer AL system 152) and wafer optical plate 132 (pan 170 not shown) are depicted schematically. Atmospheric pressure is exerted on the “top” surface of the wafer optical plate 132. The “lower” surface of the wafer optical plate 132 (situated inside the wafer-vacuum chamber 113) normally is subjected to a high vacuum (e.g., 10⁻⁶ Torr). During evacuation of the wafer-vacuum chamber 113, or whenever there is a change in atmospheric pressure outside the wafer-vacuum chamber, a corresponding pressure differential (or change) is exerted directly on the wafer optical plate 132. The pressure differential tends to pull the wafer optical plate 132 toward the wafer-vacuum chamber 113 (downward in the figure), causing the wafer optical plate 132 to exhibit deformation as shown by the dotted line in the figure. Whenever such deformation occurs, the wafer AF system 151, mounted on and supported by the wafer optical plate 132, is affected adversely by experiencing an alignment and/or positional shift.

In contrast, referring now to FIG. 6(B), the secondary reduced-pressure chamber SI and the pan 170 are located on the “top” surface of the wafer optical plate 132. Atmospheric pressure is exerted on the “top” surface of the pan 170, but not directly on the “top” surface of the wafer optical plate 132. This is because the secondary reduced-pressure chamber SI between the pan 170 and the wafer optical plate 132, evacuated by the vacuum pump 171 (FIG. 2) to a vacuum of approximately 10⁻⁴ Torr, serves to isolate the “top” surface of the wafer optical plate from atmospheric pressure. Whenever the inside of the wafer-vacuum chamber 113 is at a high vacuum (e.g., 10⁻⁶ Torr) and the secondary reduced-pressure chamber SI is at approximately 10⁻⁴ Torr, most of the pressure differential with respect to atmospheric pressure is imparted to the pan 170, not by the wafer optical plate 132. The pressure differential between external atmospheric pressure and the subatmospheric pressure inside the secondary reduced-pressure chamber S1 causes the pan 170 to deform, as indicated by the dotted line in the figure, rather than causing deformation of the wafer optical plate 132. As a result, the pressure differential has virtually no effect on the wafer optical plate 132, which substantially reduces any deformation of the wafer optical plate 132. Since the respective spaces between the pan 170 and the wafer AF system 151 are sealed by the respective closure members 186, 192 and O-rings 188, 194 (in a manner allowing a small amount of slidability of the pan 170 relative to the wafer optical plate), deformation of the pan 170 has substantially no effect on the wafer AF system 151.

Meanwhile, since deformation of the wafer optical plate 132 is reduced substantially, as described above, movements of the AF lens column 156a, the mirror chamber 161 supporting the wafer AF system 151, and the legs 166 supporting the stand 165 are reduced substantially. This reduction of deformation of the wafer optical plate 132 allows high-accuracy focusing and registration, which, in turn, allow high-accuracy lithographic exposures to be made.

If any residual deformation or a change in deformation of the wafer optical plate 132 become problematic, these deformations can be detected using a pressure sensor or deformation sensor (e.g., strain gauge). Data from the sensor can be used in feedback control of the pressure of the secondary reduced-pressure chamber S1, making it possible to cancel the residual or change in deformation.

Whereas the invention has been described in the context of representative embodiments, the invention is not limited to those embodiments. On the contrary, the invention is intended to encompass all modifications, alternatives, and equivalents as may be included within the spirit and scope of the invention, as defined by the appended claims.

What is claimed is:

1. A chamber for performing a process on a workpiece at a pressure that is lower inside the chamber than outside the chamber, comprising:
walls and at least one bulkhead that collectively define the chamber;
a secondary wall situated outside the chamber relative to the bulkhead and defining a gap between the secondary wall and the bulkhead, the gap defining a secondary reduced-pressure chamber that is pressurizable at a pressure intermediate the respective pressures inside and outside the chamber, and the secondary wall being deformable relative to the bulkhead in response to a differential of pressure inside the secondary reduced-pressure chamber relative to pressure outside the chamber.

2. The chamber of claim 1, wherein the secondary reduced-pressure chamber is isolated from pressure outside the chamber and from pressure inside the chamber.

3. The chamber of claim 1, wherein:
the chamber is configured to be evacuated to a high vacuum relative to atmospheric pressure outside the chamber; and
the secondary reduced-pressure chamber is connected to a vacuum pump configured to evacuate the secondary reduced-pressure chamber to a less-high vacuum level than inside the chamber.

4. The chamber of claim 1, further comprising:
a measurement instrument mounted to the bulkhead and extending through the secondary wall; and
seal means situated and configured to seal the secondary wall to the measurement instrument while allowing the secondary wall to move relative to the measurement instrument, without breaking the seal, in response to the differential of pressure.

5. The chamber of claim 4, wherein the measurement instrument is configured to measure a characteristic of an object inside the chamber.

6. The chamber of claim 4, wherein the seal means comprises:
a closure member extending radially from a surface of the secondary wall to the measurement instrument; and
an elastomeric sealing member extending from the closure member to the measurement instrument.

7. The chamber of claim 4, wherein:
the chamber is a wafer chamber of a microlithography system;
the object is a semiconductor wafer being processed lithographically in the chamber; and
the measurement instrument is configured for measuring at least one of focus and alignment of the object inside the chamber.

8. The chamber of claim 1, wherein:
the pressure inside the chamber is a high vacuum;
the pressure inside the secondary reduced-pressure chamber is an intermediate vacuum; and
the pressure outside the chamber is ambient atmospheric pressure.

9. The chamber of claim 1, configured as a wafer chamber or reticle chamber in a microlithography system.

10. An apparatus for housing an object in a subatmospheric-pressure, comprising:
a chamber collectively defined by vessel walls and at least one bulkhead, the chamber being sized to contain the object and to contain an atmosphere evacuated to the subatmospheric pressure;
an instrument-mounting member mounted to the bulkhead outside the chamber;
an instrument mounted to the instrument-mounting member and configured to measure a characteristic of the object in the chamber; and
a deformation-reducing device for reducing deformation of the bulkhead in response to a differential of the subatmospheric pressure inside the chamber relative to pressure outside the chamber.

11. The apparatus of claim 10, wherein:
the deformation-reducing device comprises a secondary wall situated outside the chamber relative to the bulkhead and defining a gap between the bulkhead and the secondary wall; and
the gap defining a secondary reduced-pressure chamber that is evacuated to a subatmospheric pressure intermediate the subatmospheric pressure in the chamber and the pressure outside the chamber.

12. The apparatus of claim 11, wherein the secondary wall is configured to deform relative to the bulkhead in response to a differential of pressure inside the secondary reduced-pressure chamber relative to the pressure outside the secondary reduced-pressure chamber and outside the chamber.

13. The apparatus of claim 11, further comprising seal means situated between and establishing a seal between the secondary wall and the instrument-mounting member, the seal means allowing the secondary wall to move relative to the instrument-mounting member in response to the differential of pressure, without breaking the seal.

14. The apparatus of claim 13, wherein the seal means comprises:
a closure member extending radially from a surface of the secondary wall to the measurement instrument; and
an elastomeric sealing member extending from the closure member to the measurement instrument.

15. The apparatus of claim 11, further comprising a vacuum pump connected to the secondary reduced-pressure chamber and configured to evacuate the secondary reduced-pressure chamber to the subatmospheric pressure.

16. The apparatus of claim 10, further comprising a stage situated inside the chamber and configured to hold the object inside the chamber.

17. The apparatus of claim 16, wherein:
the object is a reticle or substrate; and
the stage is a reticle stage or a wafer stage, respectively, of a microlithographic exposure system.

18. The apparatus of claim 17, wherein the instrument is selected from a group consisting of a reticle autofocus system, a reticle alignment system, a wafer autofocus system, and a wafer alignment system.

19. A system for irradiating an object with an energy beam, comprising:
a chamber collectively defined by vessel walls and at least one bulkhead, the chamber being sized to contain the object for irradiation with the energy beam and to contain an atmosphere evacuated, at least during the irradiation, to a subatmospheric pressure;
an optical system situated so as to irradiate the object in the chamber with the energy beam;
an instrument-mounting member mounted to the bulkhead outside the chamber;
an instrument mounted to the instrument-mounting member and configured to measure a characteristic of the object in the chamber; and
a deformation-reducing device for reducing deformation of the bulkhead in response to a differential of pressure inside the chamber relative to pressure outside the chamber.

20. The system of claim 19, wherein:
the deformation-reducing device comprises a secondary wall situated outside the chamber relative to the bulkhead and defining a gap between the bulkhead and the secondary wall; and
the gap defines a secondary reduced-pressure chamber that is evacuated to a subatmospheric pressure intermediate the subatmospheric pressure in the chamber and the pressure outside the chamber.

21. The system of claim 20, wherein the secondary wall is configured to deform relative to the bulkhead in response to a differential of pressure inside the secondary reduced-pressure chamber relative to the pressure outside the secondary reduced-pressure chamber and outside the chamber.

22. The system of claim 20, further comprising seal means situated between and establishing a seal between the secondary wall and the instrument-mounting member, the seal means allowing the secondary wall to move relative to the instrument-mounting member in response to the differential of pressure, without breaking the seal.

23. The system of claim 22, wherein the seal means comprises:
a closure member extending radially from a surface of the secondary wall to the measurement instrument; and
an elastomeric sealing member extending from the closure member to the measurement instrument.

24. The system of claim 20, further comprising a vacuum pump connected to the secondary reduced-pressure chamber and configured to evacuate the secondary reduced-pressure chamber to the subatmospheric pressure.

25. The system of claim 19, wherein:
the object is a lithographic wafer substrate; and
the optical system is a projection-optical system situated and configured to illuminate the substrate inside the chamber with an energy beam so as to expose the substrate lithographically with a pattern image.

26. The system of claim 25, wherein the energy beam is selected from the group consisting of vacuum UV light, extreme UV light, X-ray light, and charged particle beams.

27. A lithographic exposure system for exposing a substrate with a pattern, the system comprising:
a first chamber collectively defined by chamber walls and at least one bulkhead, the first chamber being configured (a) to contain the substrate for exposure, (b) to irradiate the substrate with an energy beam capable of imprinting the pattern on the substrate, and (c) to contain a respective atmosphere evacuated, at least during the exposure, to a respective subatmospheric pressure;
a source of the energy beam situated to direct the energy beam into the first chamber to expose the substrate;
an instrument-mounting member mounted to the bulkhead outside the first chamber;
an instrument mounted to the instrument-mounting member and configured to measure a characteristic of the substrate in the first chamber; and
a respective deformation-reducing device for reducing deformation of the bulkhead in response to a differential of pressure inside the first chamber relative to pressure outside the first chamber.

28. The system of claim 27, wherein the source comprises a projection-optical system coupled to the bulkhead of the first chamber.

29. The system of claim 28, further comprising a second chamber collectively defined by chamber walls and at least one bulkhead, the second chamber being configured (a) to contain a reticle defining a pattern to be exposed onto the substrate, (b) to irradiate the reticle with an illumination beam, and (c) to contain a respective atmosphere evacuated, at least during exposure, to a respective subatmospheric pressure;
an illumination-optical system situated and configured to direct the illumination beam into the second chamber to illuminate the reticle;
an instrument-mounting member mounted to the respective bulkhead outside the second chamber;
an instrument mounted to the instrument-mounting member and configured to measure a characteristic of the reticle in the second chamber; and
a respective deformation-reducing device for reducing deformation of the bulkhead of the second chamber in response to a differential of pressure inside the second chamber relative to pressure outside the second chamber.

30. The apparatus of claim 27, wherein the instrument mounted to the instrument-mounting member of the second chamber is selected from a group consisting of a reticle auto focus system and a reticle alignment system.

31. The system of claim 27, wherein:
the deformation-reducing device comprises a secondary wall situated outside the first chamber relative to the bulkhead and defining a gap between the bulkhead and the secondary wall; and
the gap defines a secondary reduced-pressure chamber that is evacuated to a subatmospheric pressure intermediate the subatmospheric pressure in the first chamber and the pressure outside the first chamber.

32. The system of claim 31, wherein the secondary wall is configured to deform relative to the bulkhead in response to a differential of pressure inside the secondary reduced-pressure chamber relative to pressure outside the secondary reduced-pressure chamber and outside the first chamber.

33. The system of claim 31, further comprising seal means situated between and establishing a seal between the secondary wall and the instrument-mounting member, the seal means allowing the secondary wall to move relative to the instrument-mounting member in response to the differential of pressure, without breaking the seal.

34. The system of claim 33, wherein the seal means comprises:
a closure member extending radially from a surface of the secondary wall to the measurement instrument; and
an elastomeric sealing member extending from the closure member to the measurement instrument.

35. The system of claim 31, further comprising a vacuum pump connected to the secondary reduced-pressure chamber and configured to evacuate the secondary reduced-pressure chamber to the subatmospheric pressure.

36. The system of claim 35, wherein the vacuum pump is further configured to change the subatmospheric pressure in the secondary reduced-pressure chamber in response to a change in pressure outside the first chamber.

37. In a method for processing a workpiece under a subatmospheric-pressure condition established within a chamber collectively defined by vessel walls and at least one bulkhead, a method for reducing deformations of the bulkhead resulting from changes in a differential of pressure inside the chamber relative to pressure outside the chamber, the method comprising:
placing a secondary wall outside the chamber relative to the bulkhead so as to define a gap between the secondary wall and the bulkhead, the gap defining a secondary reduced-pressure chamber; and
evacuating the secondary reduced-pressure chamber to a subatmospheric pressure intermediate the subatmospheric pressure in the chamber and the pressure outside the chamber, wherein the secondary wall deforms relative to the bulkhead in response to a differential of pressure inside the secondary reduced-pressure chamber relative to the pressure outside the secondary reduced-pressure chamber and outside the chamber.

38. A microlithography system that illuminates a selected region on a pattern-defining reticle with an energy beam, and projects and focuses the energy beam, that has passed through the reticle, onto a selected region on a sensitive substrate so as to transfer the pattern from the reticle to the sensitive substrate, the microlithography system comprising:
a reticle-vacuum chamber that accommodates a reticle stage on which the reticle is mounted, the reticle-vacuum chamber being defined by respective walls and at least one respective bulkhead;
a wafer-vacuum chamber that accommodates a wafer stage on which the sensitive substrate is mounted, the wafer-vacuum chamber being defined by respective walls and at least one respective bulkhead;
a respective instrument mounted on the bulkhead of the reticle-vacuum chamber and configured to measure a characteristic of the reticle;
a respective instrument mounted on the bulkhead of the wafer-vacuum chamber and configured to measure a characteristic of the substrate; and
a deformation-reducing device for reducing deformation of the respective bulkhead of at least one of the chambers in response to a differential of pressure inside the respective chamber relative to pressure outside the respective chamber.

39. The system of claim 38, wherein:
the deformation-reducing device comprises a respective secondary wall situated outside the respective chamber relative to the respective bulkhead and defining a gap between the respective bulkhead and the respective secondary wall; and
the gap defines a respective secondary reduced-pressure chamber that is evacuated to a respective subatmospheric pressure intermediate the subatmospheric pressure inside the respective chamber and the pressure outside the respective chamber.

40. The system of claim 39, wherein the secondary wall is configured to deform relative to the respective bulkhead in response to a differential of pressure inside the respective secondary reduced-pressure chamber relative to pressure outside the respective secondary reduced-pressure chamber and outside the respective chamber.

41. The system of claim 39, further comprising seal means situated between and establishing a seal between the secondary wall and the instrument-mounting member, the seal means allowing the respective secondary wall to move relative to the instrument-mounting member in response to the differential of pressure, without breaking the seal.

42. The system of claim 41, wherein the seal means comprises:
a closure member extending radially from a surface of the secondary wall to the measurement instrument; and
an elastomeric sealing member extending from the closure member to the measurement instrument.

43. The system of claim 39, further comprising a respective vacuum pump connected to the respective secondary reduced-pressure chamber and configured to evacuate the secondary reduced-pressure chamber to the respective subatmospheric pressure.

44. The system of claim 38, comprising a first deformation-reducing device for reducing deformation of the bulkhead of the reticle-vacuum chamber, and a second deformation-reducing device for reducing deformation of the wafer-vacuum chamber, in response to respective pressure differentials being established in the respective chambers relative to outside the respective chambers.

45. The system of claim 44, wherein each deformation-reducing device comprises:
a respective secondary wall situated outside the respective chamber relative to the respective bulkhead and defining a respective gap between the respective bulkhead and respective secondary wall; and
each respective gap defines a respective secondary reduced-pressure chamber that is evacuated to a respective subatmospheric pressure intermediate the subatmospheric pressure in the respective chamber and the pressure outside the respective chamber.

46. The system of claim 44, wherein each secondary wall is configured to deform relative to the respective bulkhead in response to a differential of pressure inside the respective secondary reduced-pressure chamber relative to pressure outside the respective secondary reduced-pressure chamber and outside the respective chamber.

47. The system of claim 44, further comprising a respective seal means situated between and establishing a seal between each respective secondary wall and the respective instrument-mounting member, the seal means allowing the respective secondary wall to move relative to the respective instrument-mounting member in response to the differential of pressure, without breaking the respective seal.

48. The system of claim 47, wherein each seal means comprises:
a respective closure member extending radially from a surface of the respective secondary wall to the respective measurement instrument; and
a respective elastomeric seal extending from the respective closure member to the respective measurement instrument.

49. The system of claim 49, further comprising a respective vacuum pump connected to the respective secondary reduced-pressure chamber and configured to evacuate the secondary reduced-pressure chamber to the respective subatmospheric pressure.

50. The system of claim 44, wherein:
the respective instruments mounted on the bulkhead of the reticle-vacuum chamber are selected from the group consisting of a reticle autofocus system and a reticle alignment system; and
the respective instruments mounted on the bulkhead of the wafer-vacuum chamber are selected from the group consisting of a wafer autofocus system and a wafer alignment system.

51. The system of claim 44, wherein the bulkhead of the reticle-vacuum chamber and the bulkhead of the wafer-vacuum chamber are mounted to opposite ends of a projection-optical system extending between the chambers.

52. The system of claim 51, wherein:
the bulkhead of the reticle-vacuum chamber is configured as a reticle optical plate; and
the bulkhead of the wafer-vacuum chamber is configured as a wafer optical plate.

53. The system of claim 51, wherein:
the reticle-vacuum chamber comprises a second bulkhead situated opposite the respective bulkhead relative to the respective walls; and
the second bulkhead is connected to an illumination-optical system.

54. The system of claim 38, wherein:
the reticle-vacuum chamber is coupled to a reticle-loader chamber and a reticle load-lock chamber; and
the wafer-vacuum chamber is coupled to a wafer-loader chamber and a wafer load-lock chamber.
